(19) United States
(12) Patent Application Publication
(10) Pub. No.: US 2007/0118671 A1
(43) Pub. Date: May 24, 2007

(54) Lightweight handheld electronic notebook for reading

(76) Inventor: Sastry K. Ganti, Buffalo Grove, IL (US)

Correspondence Address: SASTRY K. GANTI, 1074 CROFTON LANE, BUFFALO GROVE, IL, 60089-4114, US

(21) Appl. No.: 11/487,628

(22) Filed: Jul. 17, 2006

Related U.S. Application Data
(60) Provisional application No. 60/737,892, filed on Nov. 18, 2005.

(51) Int. Cl. G06F 3/00; G09G 5/00

(52) U.S. Cl. 710/1; 345/1.1

(57) ABSTRACT

Paperimage is a lightweight, notebook size, portable electronic product, with one or more display screens, and shaped in the form of a foldable notebook or a tablet. It has multiple connecting ports of multiple types so that multiple compatible equipments can be connected to it to transmit and receive electronic data among the connected equipments. Its functions, at minimum, are displaying, receiving, transmitting and organizing of readable text and graphic documents in electronic form. Walletimage is a miniature version of Paperimage, suited to be carried in the pocket of one's clothing. Its primary function is to carry electronically, information of items normally in a wallet, such as credit cards, business cards, purchase receipts, et cetera. It can also receive and store data that is normally meant to be displayed by Paperimage, as well as transmit data to other compatible equipments.

### BACKGROUND OF THE INVENTION

1. Field of invention

This invention relates to lightweight, hand-held, notebook size electronic equipment,—termed here as Paperimage, and a similar but miniature size version of Paperimage,—termed here as Walletimage, both of which can display readable documents resembling printed paper, and also are well suited to receive, transmit, and organize such documents.

2. Prior Art

Ubiquitous electronic and electro-mechanical compatible equipments, such as notebooks (laptops), personal computers (PCs), personal desktop assistants (PDAs), scanners, fax machines, printers, cell phones, et cetera are available in a variety of makes and models. Individuals, companies and institutions own and use them as a matter of routine all over the world.

The mentioned equipments routinely use printers to make ‘hard copies’, and in turn copiers efficiently produce multiples of the printed ‘hard copies’. In the process paper and ink are consumed. Readable and displayable electronic data is created within such equipment, or it is ‘downloaded’ from a different source. Very often at the end of the process a paper document is created at a printer. Such printing and copying tasks are routine. Estimated in millions, ‘hard copies’ are produced every day all over the world, thus consuming a lot of paper and ink. By any measure, this consumption of paper and ink is unfriendly to the environment when carried out to excess.

The talk of computers reducing paper usage has been around since many years. However the fact is that computers have actually encouraged more use of paper and ink and have vastly increased the number of printers in use. Clicking on ‘print’ at the personal computer is an easy, and frequently executed command.

Use of printers coupled to computers makes printing very easy. As a matter of fact a printer in close proximity to a computer makes not only printing of a finalized document very easy, but also encourages printing the interim drafts of the document. Though a document can be read on the screen of a computer display, for several reasons it seldom satisfies or convinces the author as to be the true and trusted final version. Also, the document inside the computer does not lend itself to be carried and displayed at the will of the individual in varied physical locations at any desired moment. ‘Hard copies’ in the form of paper sheets or a bound book can fulfill the needed flexibility.

Some of the inconveniences of looking at a document displayed on computer's screen and reading it are cited below:
One—The display is generally in a fixed location and the individual has to move in close proximity to it;
Two—beyond the document's borders there is always the clutter of the computer display's icons, menu bars and other graphics;
Three—the borders of the document themselves have cryptic graphics generated by the relevant software programs in-charge of the document;
Four—the display screen frame showing the document is generally resizable horizontally and vertically either by zooming or by stretching its borders and corners. It is also re-locatable on the display screen. Such flexibility introduces ‘scroll bars’, border and corner ‘handles’ and other graphics to the document's borders. The display may be minimized in size or made to disappear all together except for its representative icon in a corner. All this sophistication tends to disturb the focus of the reader from the contents of the document and leaves him/her less than confident about reading the contents of the document on computer screen.
Five—Unlike the finality of the look of a printed sheet, the displayed document is alive and connected to its manipulative program. It may unintentionally or erroneously get modified or not get modified,—in opposition to the author's desires, upon closing the ‘application program’.
Six—the displayed view of the document on the computer is temporary. There is no absolute assurance that the viewer will see exactly the same presentation again, when the ‘application program’ and the document are opened again.
Seven—several other documents may be simultaneously visible on the computer screen and their ‘application programs’ are active, giving the appearance of the display screen a desk cluttered with overlapping sheets of paper.
Eight—There may be other un-assuring factors, such as computer crashing, display lock-up, et cetera while manipulating a document on computer screen.

Because of the factors cited, many readers are not comfortable until they can look at a document's paper version, one whose look will remain same regardless of the passage of time or the document's physical location.

Hence the existence of one's desire to print, and print again. The reader may imagine the disorganized accumulation and the clutter of printed copies of paper documents on desks, shelves, residences, businesses, institutions, archives and storage areas all over the world! A vast majority of these excess sheets of paper will never be located or looked at with purpose. Possessing the printed versions seems to give security to individuals. One must not forget that papers, with the use of machine power, are not only routinely printed, but also they are trimmed, glued, stapled, folded, bound, boxed, transported, et cetera. These functions done in excess are all expensive and environmentally unfriendly.

The existing ease of printing and use of computers of all types has given rise to the presence of large quantities of printers. The eagerness to print is so strong that in a short time of a few years, use of personal printers placed in the proximity of personal computers on the desk has become a common sight. It is also possible for service oriented and frequently traveling individuals carrying ‘laptops’, also to carry printers in the carrying cases.

Printers are, to a substantial portion of their making, mechanical devices. They use gears, rollers, belts, pulleys, et cetera and ink dispensers. Any one of these items could malfunction and they routinely do. Discarding these items, or the entire printer itself is quite common, and that is also not environmentally friendly. The environmental problem is more acute with the handling or disposing off of ink dispensers and related items. Excessive paper consumption is also detrimental to a pristine or cultivated landscape. Using both sides of a paper with print is seldom done. Single side printing, conveniently executed with a printer or a copier, uses double the pages of an equivalent book of the same content printed double side.

Consider also the following familiar scenes and routine actions, related to the printed paper, that add stress to modern living:
A. An individual makes purchases at gas stations, grocery stores, department stores, or executes financial transactions at ‘ATMs’ (Automated Teller Machines) and such other places. Within every cash register or ‘ATM’ there is generally a printer, and thus the individual is quickly annoyed with numerous receipts that may be randomly placed in automobile, wallet, residence or simply discarded loose in the environment. If the printer part of the ATM is malfunctioning, it adds to the annoyance.
B. An individual or a family periodically decides to locate and set to archives all household papers, such as utility bills, bank statements, tax forms, telephone records, papers on a variety of repair services, et cetera for the past few years or more. This task involves handling a lot of paper. Periodically, ‘junk mail’ and envelopes have to be separated from the ‘good mail’. Mail needs to be collected, sorted and retained or disposed off. Sensitive ‘junk mail’, often related to credit cards and financial institutions, may have to be shredded as well, before disposal.
C. An individual at work place tries to organize the desk cluttered with papers and publications. The papers might include letters, catalog sheets, price sheets, purchase orders, trade magazine articles, part drawings, memos, printed e-mails and many other varieties of documents. The employee's networked personal computer with its internet connections and a printer in close proximity, encourages printing frivolous documents also. The reasons for printing have already been given earlier. The individual handling electronic documents needs to learn many computer skills, constantly being ‘upgraded’. A professional highly skilled in the relevant profession, also needs to be highly skilled in using the computer. The sight of a cluttered desk of papers is stressful enough, but the sight of a neat and organized desk may hide the stress involved in the constant maintenance of the neatness.
D. Visualize a conference or gathering of several people in a meeting, seminar, class room, et cetera. The lead chair-person meticulously prepares and distributes a stack of notes to all attendees. A lot of paper is thus consumed and a lot of effort is exerted to keep everyone on the same page.

Summarizing the prior art, related to the field of the present invention dealing primarily with readable paper documents,
excess of paper, ink, and machines are being utilized resulting in too many documents to deal with. All mentioned items add to the detriment of environment as well as stress to an individual's life. The individual is often overwhelmed at the task of organizing and retrieving personal paper documents.

Summarizing the prior art, related to the field of the present invention dealing primarily with computer displayed documents,
many individuals are not completely comfortable reading documents displayed on a computer screen. Also, the computer is not as portable as a sheet of paper or a book is. It is also not as quick to locate and display documents as a book is.

### OBJECTS AND ADVANTAGES

The present invention has the following objects and advantages:
It will drastically reduce the need for paper printing, thus contributing to a friendly environment;
It will drastically reduce the need for printing ink, thus contributing to a friendly environment;
It will drastically reduce the need for printing machines, thus contributing to a friendly environment;
It will make the availability of readable electronic documents very easy; It will virtually eliminate any limitations on the physical location for availability of a readable electronic document;
It will vastly increase the ease of sharing readable electronic documents;
It will drastically reduce the need for paper receipts at points of purchasing;
It will economize various tasks associated with paper, namely,—paper production, paper cutting, printing, gluing, stapling, binding, shipping, storing, et cetera;
It will lead to an organized and uncluttered desk or table at any physical location;
It will economize the efforts needed by institutions such as banks, utility companies, phone companies, postal service, governments, et cetera in servicing people;
It will make it easier for an individual to organize, store and retrieve important personal documents in the electronic digital format, without the need of computers or computer skills;
It will ease the tasks of educators in the classroom environment, giving them more time to educate, and requiring of them less time spent on anything related to paper documents;

It will simplify efforts by governments to reduce paper and paperwork. Many document based contested issues will be resolved faster and amicably.

### SUMMARY

In accordance with my invention, Paperimage and Walletimage will drastically improve the ease with which readable text and graphic documents can be received, transmitted, shared and read, in digital electronic displays, by single or multiple individuals, located in a variety of physical settings, without the need of paper, ink, printers, and copiers. Paperimage and Walletimage are light-weight utility devices requiring nominal skills. The invention will have a positive impact on the earth's environment.

### DRAWINGS, FIGURES

FIG. 1 Unfolded Paperimage with two display screens, front view

FIG. 2 Unfolded Paperimage, rear view

FIG. 3 Unfolded Paperimage with single display screen, front view

FIG. 4 Unfolded Walletimage with single display screen, front view

FIG. 5 Unfolded Walletimage, rear view

FIG. 6 Combination ‘piggy-back’, and data transmission chord connected Paperimages and Walletimages

FIG. 7 ‘Piggy-back’ connected stack of Walletimages

FIG. 8 Combination of ‘piggy-back’ and data transmission chord connected Walletimages

FIG. 9 Combination of interconnected Paperimages, Walletimages and a document scanner

FIG. 10 Combination of interconnected Paperimages, Walletimages and a personal computer

FIG. 11 Paperimages in tablet form, with a sliding close-coupling connector

FIG. 12 Close-up view of tablet form Paperimage at sliding close-coupling connection.

FIG. 13 Four close coupled tablet form Paperimages

FIG. 14 Conference table with Paperimages

FIG. 15 Interconnected Paperimages, Walletimages and a multi-function machine (print, scan, fax, et cetera)

FIG. 16 Walletimage in tablet form, with sliding type male connector for close-coupling connection in retracted position

FIG. 17 Walletimage in tablet form, with sliding type male connector for close-coupling connection in advanced position

FIG. 18 Two Walletimages in tablet form, close coupled

FIG. 19 Concept of a futuristic institutional communication station for Walletimages and Paperimages for docking and information transmission

FIG. 20 Close-up view of a Walletimage at the futuristic institutional communication station, and docking port

FIG. 21 Concept of a Walletimage docked at a futuristic checkout counter in a supermarket or shopping center conveyor, for exchange of credit card and purchase receipt information.

FIG. 22 Paperimages and Walletimages connected to each other in ‘piggy-back’, close-coupling, and data transmission cable methods

### DRAWINGS, REFERENCE NUMERALS

30 Display screen, first, Paperimage with two display screens
31 Display screen, second, Paperimage with two display screens
32 Typical operational button (examples: on, off, copy, display next page, et cetera), Paperimage
33 Memory expander or external document data card in slot, Paperimage
34 Male connector, for ‘piggy-back’ docking with compatible equipment, Paperimage
35 Typical data transmission chord connector ports, Paperimage
36 Cavity pocket over male connector upon folding of Paperimage
37 Power chord/battery charger, Paperimage
41 Female connector, for ‘piggy-back’ docking with compatible equipment, Paperimage
42 Data transmission chords' storage, Paperimage
43 Power chord/battery charger connection port, Paperimage
44 Battery compartment, Paperimage
50 Display screen, Walletimage
51 Typical data transmission chord connector ports, Walletimage
52 Power chord/battery charger connection port, Walletimage
53 Typical operational button (examples: on, off, enter password, transmit, et cetera), Walletimage
54 Male connector, for ‘piggy-back’ docking with compatible equipment, Walletimage
55 Cavity pocket over male connector upon folding of Walletimage
56 Battery compartment, Walletimage
57 Female connector, for ‘piggy-back’ docking with compatible equipment, Walletimage
58 ‘Piggy-back’ connected Paperimages and Walletimages
59 Typical data transmission chord
60 Document scanner
62 Personal computer
64 Display monitor for personal computer
70 Display screen, tablet form Paperimage
72 Typical operational button (examples: on, off, copy, display next page, et cetera), tablet form Paperimage
74 sliding type male connector for close-coupling connection, in retracted position, tablet form Paperimage
76 sliding type male connector for close-coupling connection, in advanced position, tablet form Paperimage
77 Multi-function machine (print, scan, fax, et cetera)
78 Typical data transmission chord connector ports, Walletimage in tablet form
79 Data transmission chord at Walletimage in tablet form

### DETAILED DESCRIPTION, PREFERRED EMBODIMENT OF LIGHTWEIGHT HANDHELD ELECTRONIC NOTEBOOK FOR READING

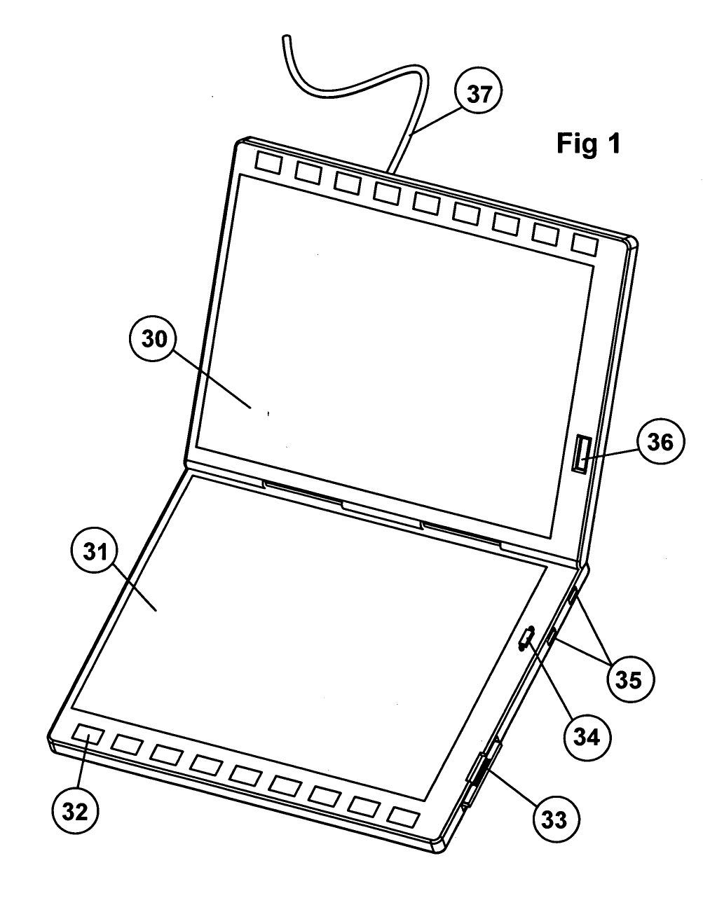

The preferred embodiment of the present invention is the Paperimage in the form of a foldable electronic notebook with two or one display screens, or in tablet form with one display screen. FIGS. 1, 2, 3, and 11.

Paperimage is a light-weight, hand-held electronic equipment, expected to be easily carried by a child or a person of advanced age. The basic model Paperimage with minimum of features will be able to receive, store, rearrange, retrieve, transmit, and display data in the form of readable display pages. It will have an operating system with the logic to carryout the mentioned basic functions. At the basic model level, to keep it lightweight: it is not expected to manipulate and modify data like computers; it is not expected to possess an operating system that handles application programs; it is not expected to possess any mechanical drives. Reading its display is expected to resemble reading a paper document with the same or better ease, comfort and convenience. The physical design of all its components is expected to be lightweight yet rugged.

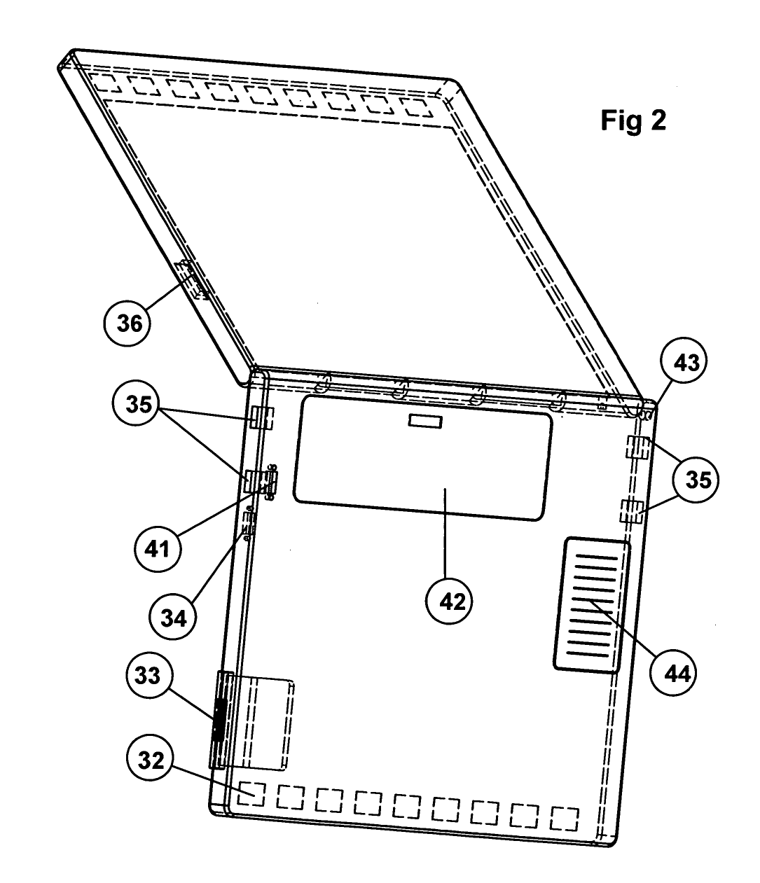

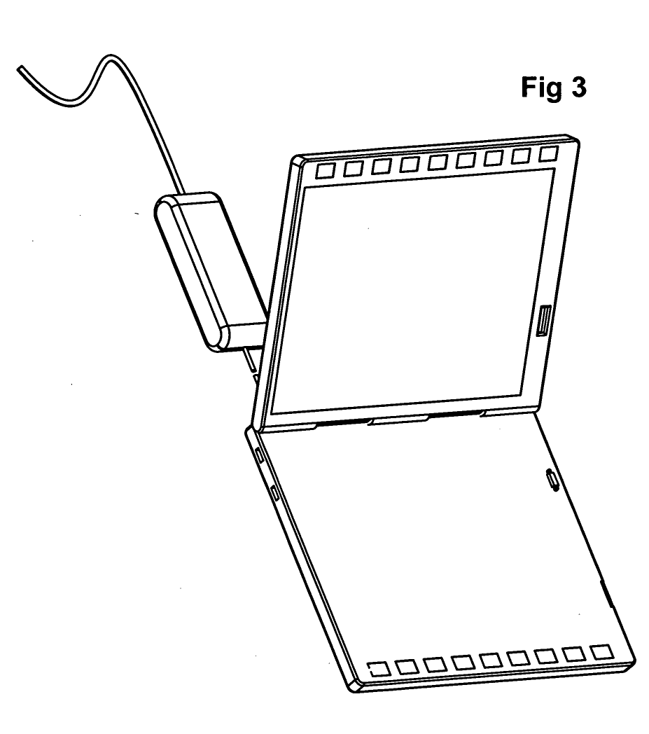

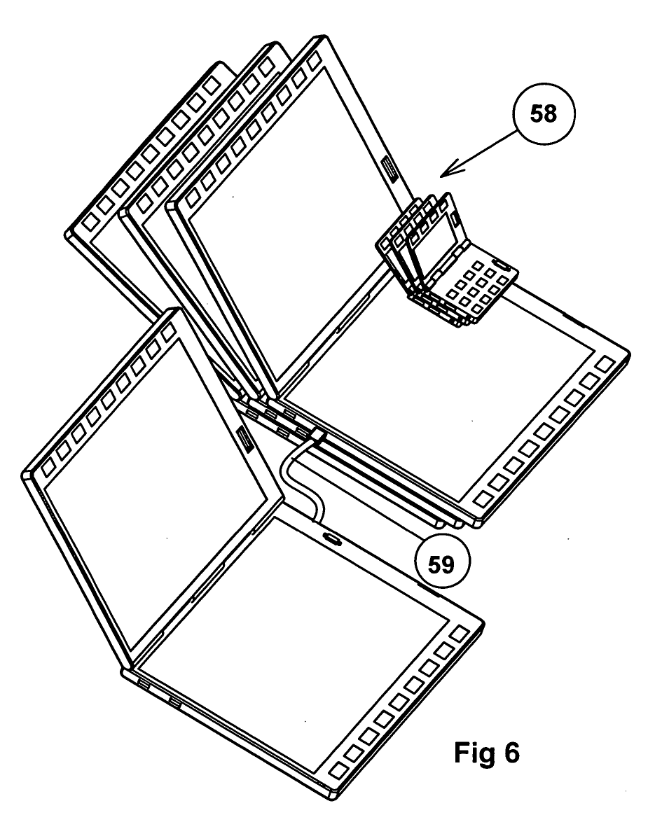

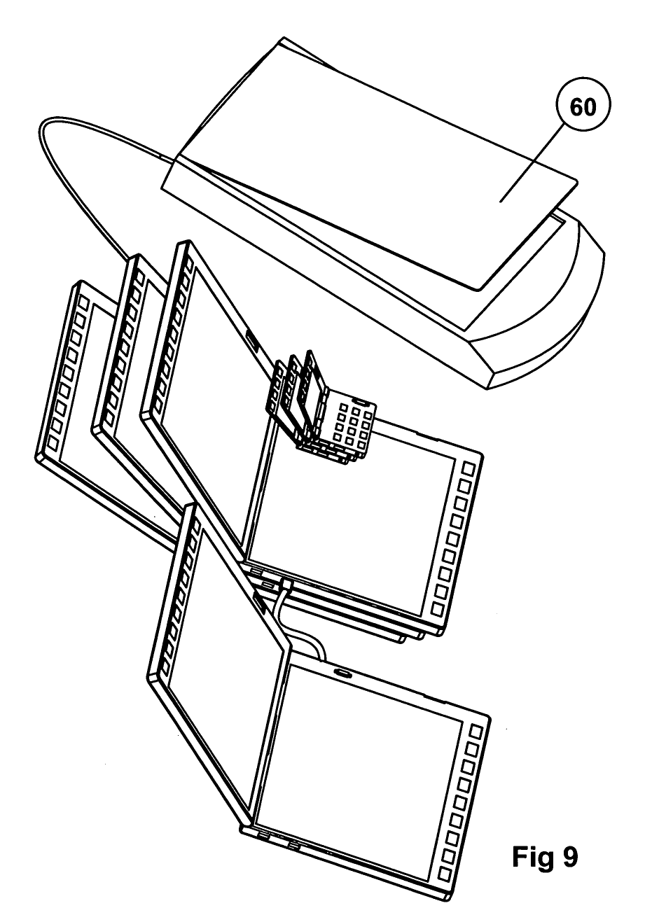

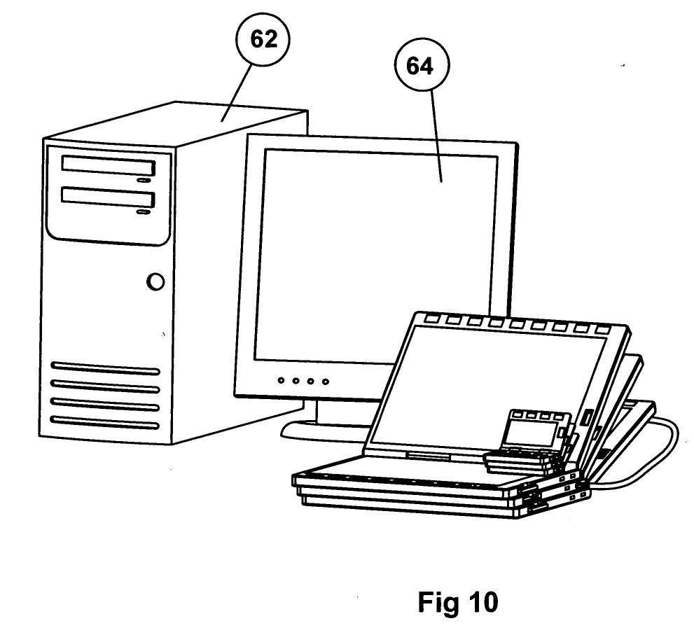

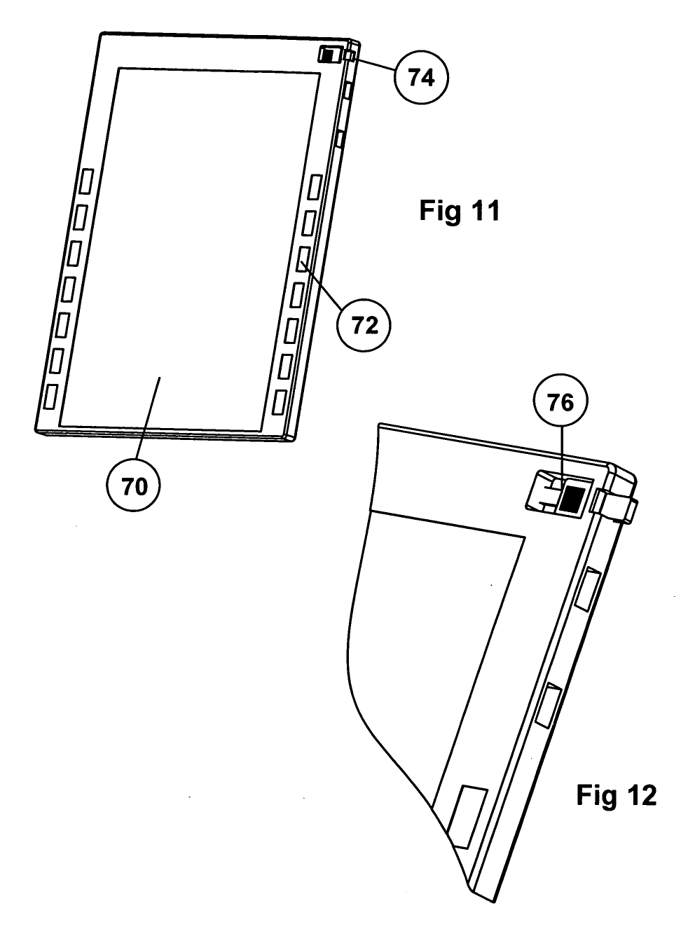

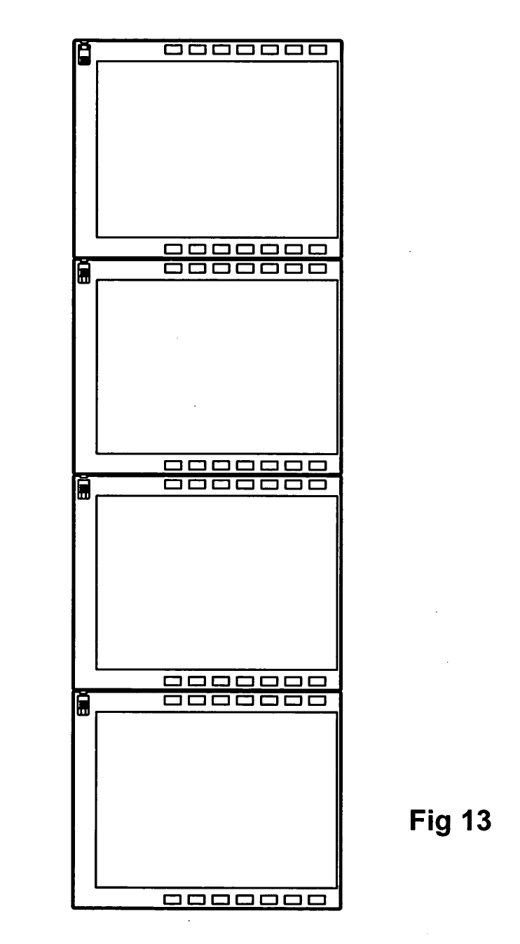

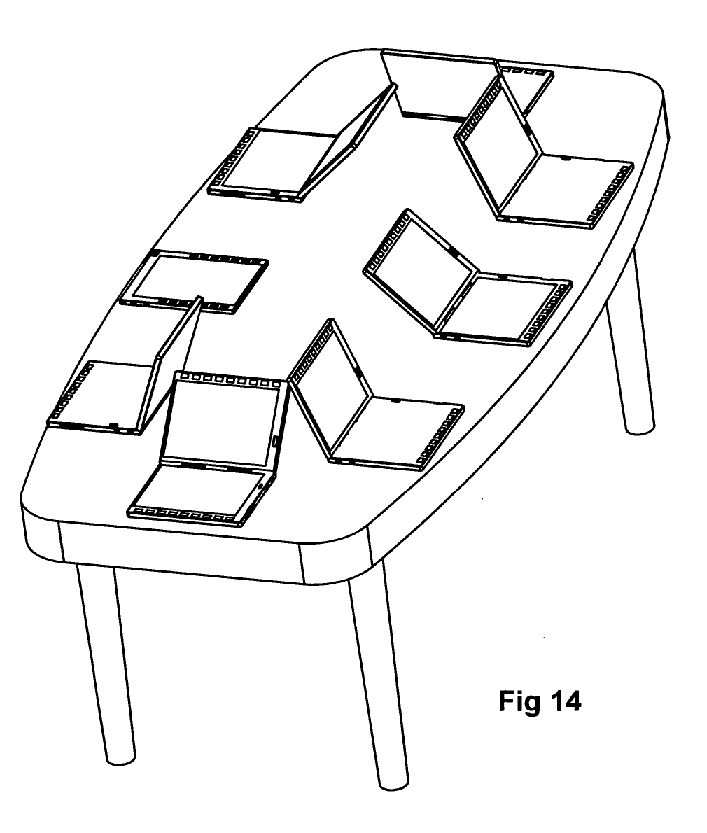

The dual display screen Paperimage is shown in FIGS. 1 and 2.
Shown in FIG. 1:
   30 and 31 are the screens to display readable text and graphics, much like the pages of any paper book.
   32 is a typical button required to operate the various functions of Paperimage.
   33 is snap-in type memory expander card or data extension card in a slot.
   34 is a male connector by which another Paperimage or compatible equipment can be connected ‘piggy-back’ style without any cable.
   35 are multiple connection ports for data transmission chords. Multiple compatible equipments can be connected.
   36 is a hollow pocket to shroud connector port 34 when the Paperimage notebook is folded closed.
   37 is a power supply chord, in partial view, for connecting Paperimage to a standard wall outlet.
Shown in FIG. 2:
   41 is the female socket complementing the male connector 34, so that the Paperimage being described can be docked ‘piggy-back’ to another compatible equipment.
   42 is storage space for data transmission chords.
   43 is the socket for power chord connection for Paperimage operation and battery recharging, in case batteries are the rechargeable type.
   44 is the battery compartment.
Shown in FIG. 3 is a Paperimage with a single screen.
Shown in FIG. 6 are Paperimages docked to each other, and to a stack of Walletimages described in alternate embodiment. The figure also shows a data transmission chord connecting a Paperimage to another one of a group.
Shown in FIG. 9 is a scanner connected to Paperimages, and Walletimages described in alternate embodiment.
Shown in FIG. 10 is a personal computer connected to Paperimages, and Walletimages described in alternate embodiment.
Shown in FIG. 11 is a Paperimage in the tablet form.
   70 is the display screen, for Paperimage in the tablet form.
   72 is a typical functional button to operate the Paperimage in tablet form.
   73 is a ‘close-coupling’ sliding connector, shown in retracted or ‘tucked-in’ position.
Shown in FIG. 12 is a close-up view of sliding connector 76, shown in advanced, connecting position, for Paperimage in tablet form.
Shown in FIG. 13 are four close-coupled tablet form Paperimages.
Shown in FIG. 14 is a conference table with Paperimages. This eliminates the need for the conference chair-person to supply paper notes.
Shown in FIG. 15 is a multi-function machine (printing, faxing, scanning, et cetera) connected to Paperimages, and Walletimages described in alternate embodiment.

### OPERATION OF PREFERRED EMBODIMENT, LIGHTWEIGHT HANDHELD ELECTRONIC NOTEBOOK FOR READING

The primary novel feature in the use and operation of Paperimage is the ease of quickly connecting multiples of its own type and compatible equipments in multiple ways, in a multitude of physical locations, to transmit electronic data from any one of the connected equipments to any number of the remainder of connected equipments, without changing the connection setup. If all of the connected equipments are hand held devices, then the physical location for connecting and transmitting are virtually limitless. Any connected equipment capable of transmission can be the transmitter. All connected equipments capable of receiving can be receivers. In the illustrations, only physical connections,—of the type with chords, piggy-back style, close coupling connectors, et cetera, have been shown. Remote wireless connections may also be used for connectivity.

The normal predominant use of Paperimage is to display internally stored electronic data of pages of text and graphics. This data can be obtained through the means described. The reader will notice that paper copies will be unnecessary when readable documents are transferred into a Paperimage through any compatible equipment, or through snap-in type memory card.

The following illustration will describe the ‘no need of paper copies’ mentioned: A foursome has just finished golfing and are about to walk back to their cars. One mentions that he/she has in possession several interesting pages of ball hitting techniques as ‘downloaded digital documents’ in his/her Paperimage. Another one of them mentions that he/she has numerous historical trivia of mutual interest, obtained by scanning paper documents in the local library and digitizing them into Paperimage documents. All of them desire to possess copies of all documents mentioned.

All that is needed then and there is, each one of them have with them their Paperimages. With the Paperimages connected in any one of the various methods possible, and with all of them turned on, all but one of the Paperimages will be set to receiving mode. One would be set to transmitting mode. The electronic data storage memory of the Paperimages is expected to be organized into chapters/folders. Hence the transmitting location for one and the receiving locations for three may also be specified using the relevant operational buttons of respective Paperimages. A push on the ‘Transmit’ button of the appropriate Paperimage will start the transmission of documents to all connected Paperimages.

If one or more of them do not have their Paperimages at hand, they may use their Walletimages (described in alternate embodiment) to receive the information, and later re-transmit it to Paperimages. The individuals, after reaching their homes may copy the data pages into other Paperimages or compatible equipments, probably designated as spares, archives, personal libraries, et cetera. All processes described above do not involve paper or printing, or a knowledge of computers.

There can be several varieties of logics written for the intelligence of the operating system of Paperimage. Also, in the above illustration, after the completion of transmission from one Paperimage to the rest connected, for further transmission of data from another connected equipment, the modes of operation of all the connected equipments could be reset and revised. A different appropriate ‘Transmit’ button will then have to be depressed for the new transmission. In a particular transmission, if one of the equipments does not need the transmission, then it will be set to ‘by-pass’; thus it will behave simply as a connector.

The reader may infer that a multitude of variations in the operation of Paperimage can exist to receive or transmit readable pages of documents, without the need of paper, printer or copier. With the aid of other operational buttons, electronic pages can be organized within desired storage locations of a Paperimage. Since there are no programs to be opened to manipulate and modify the data by the user of a basic Paperimage, data display and data transmission can be at very high speeds. With a Paperimage in possession, data pages can be displayed virtually at any physical location for looking and reading, just as though one possesses the paper copy.

### DESCRIPTION AND OPERATION, ALTERNATIVE EMBODIMENT of LIGHTWEIGHT HANDHELD ELECTRONIC NOTEBOOK FOR READING

The alternative embodiment of the invention is a miniaturized version of Paperimage, termed Walletimage. It is small enough to be carried in a pocket of worn clothing. Its electronic data is expected to represent substantially all that is normally carried in a wallet, except cash; namely,—credit cards, business cards, receipts, telephone lists and such contact information, et cetera. As a futuristic concept, with secure data storage locations, Walletimage can also be equipped with electronic signature authorization for credit card purchases. It will also be able to store data of full size pages, in a similar fashion to Paperimage; however, its display capabilities of a full page may be limited due to its smaller size.

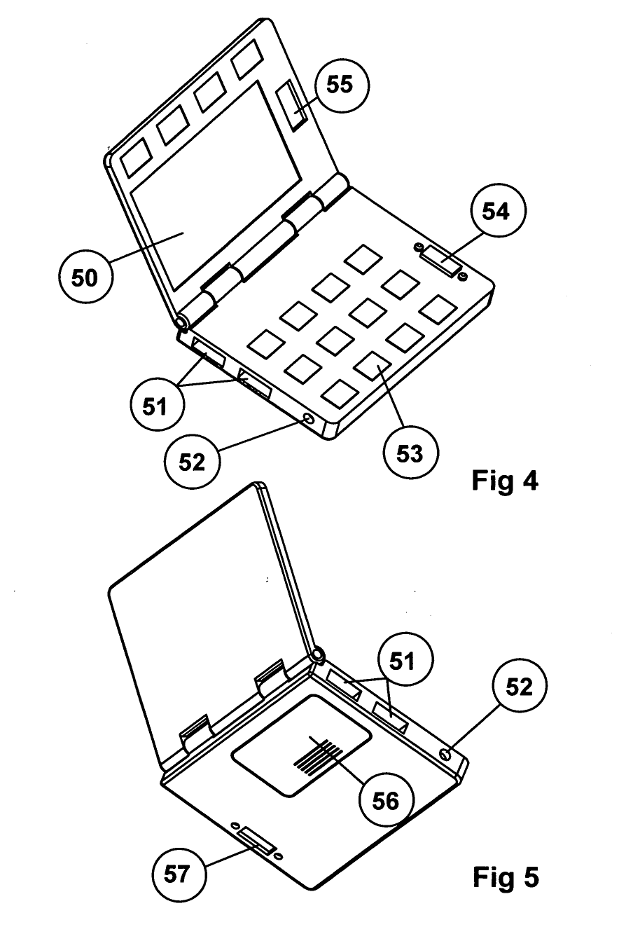

FIG. 4 shows the display screen view of Walletimage in the form of an unfolded notebook.
50 is the display screen, large enough to clearly display images of small documents, such as credit cards, business cards, et cetera.
51 is typical of multiple connector ports for data transmission chord.
52 is Power chord/battery charger connection port, for Walletimage.
53 is a typical button required to operate the various functions of Walletimage.
54 is a male connector for ‘piggy-back’ docking to another compatible equipment.
55 is a hollow pocket to shroud the male connector, when the Walletimage is folded shut.

FIG. 5 shows the back side of a Walletimage.
56 is the battery compartment.
57 is the female connector port complementing 54, for ‘piggy-back’ docking.

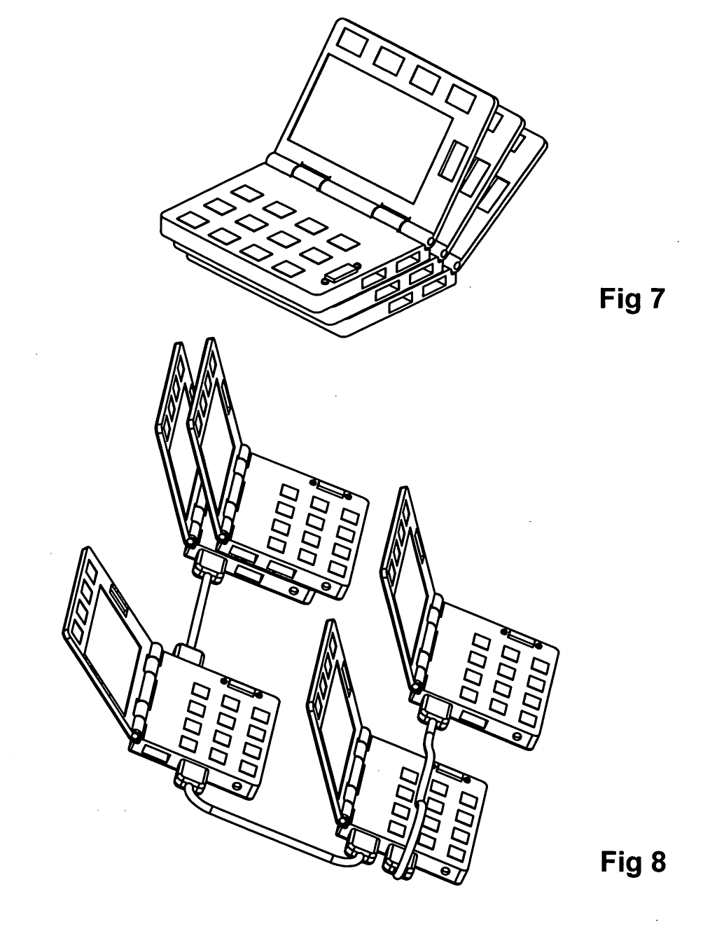

FIGS. 6, 7, 8, 9, 10, 15 show notebook style Walletimages in a variety of situations and connections.

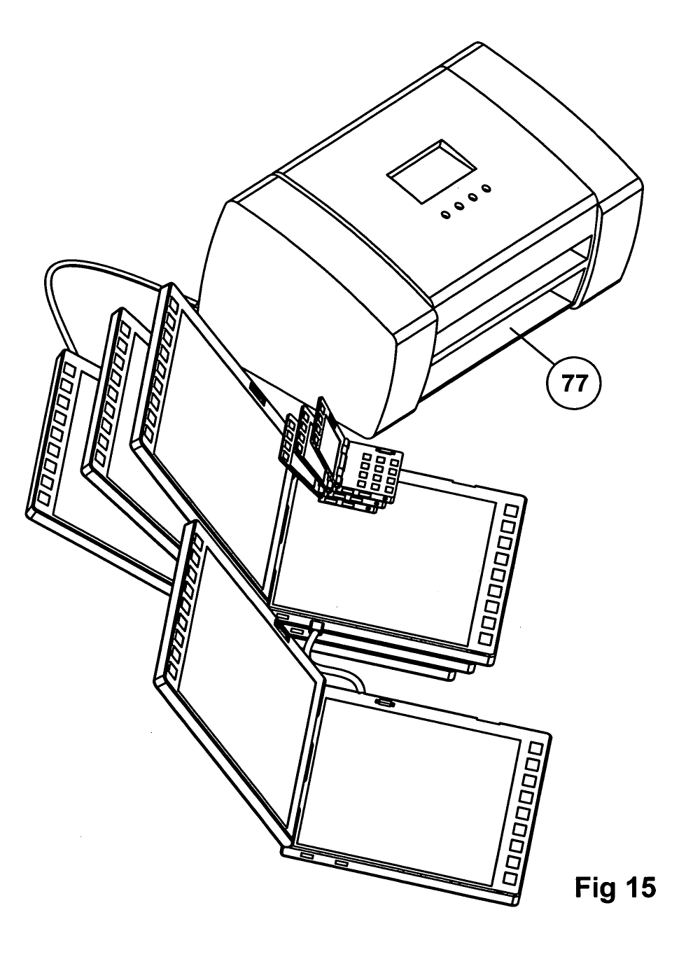

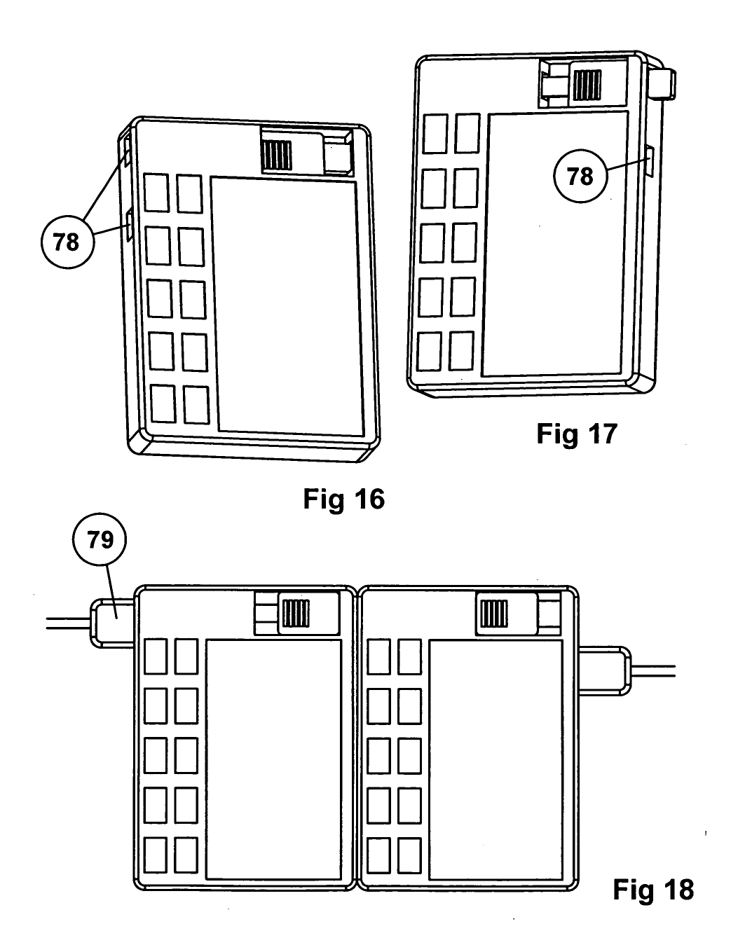

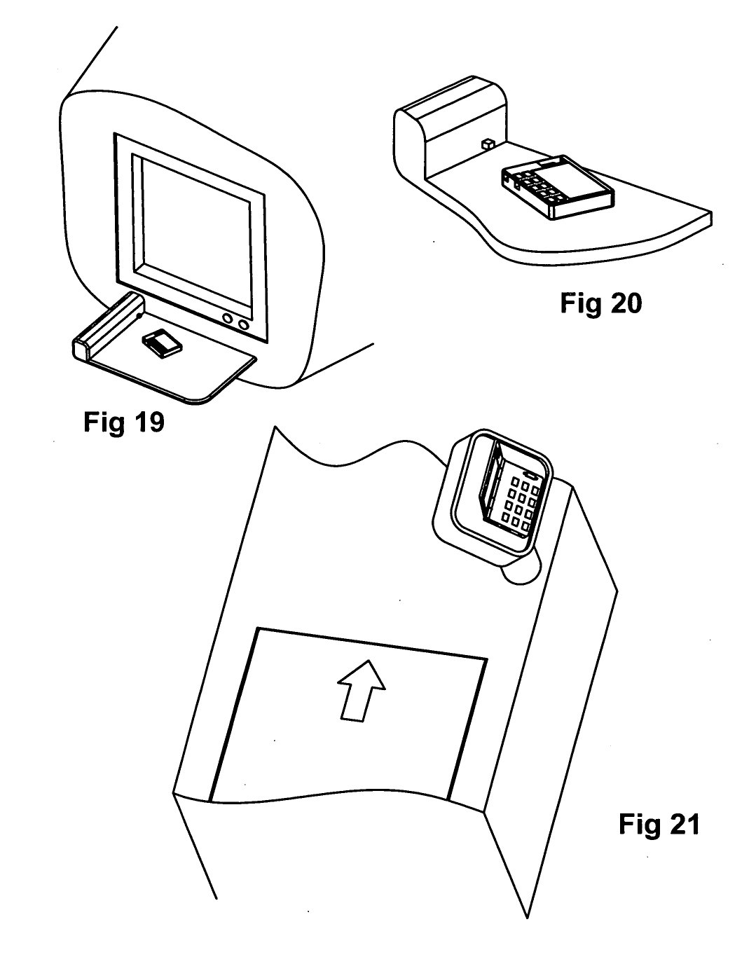

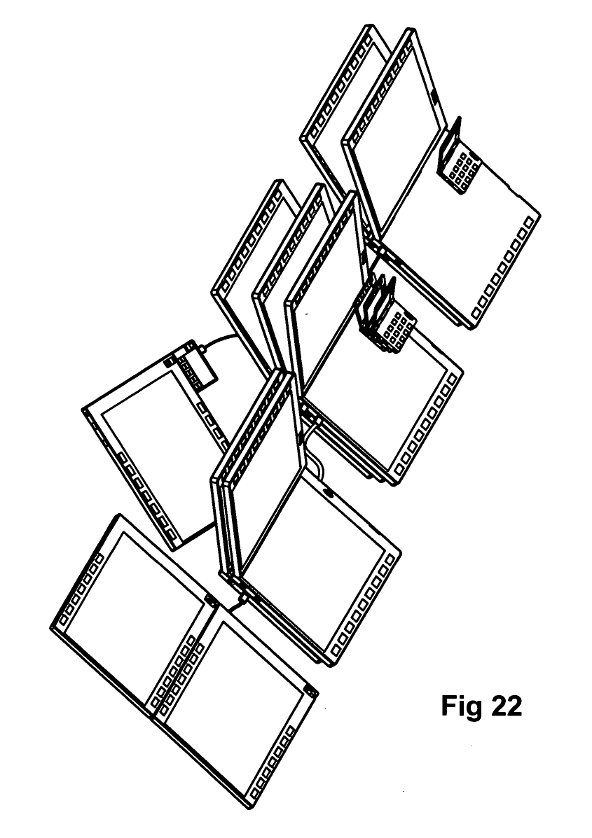

FIG. 16 shows a tablet form of Walletimage with a sliding type connector shown in retracted position.
78 is a typical data transmission chord connecting port for Walletimage.

FIG. 17 shows a tablet form of Walletimage with a sliding type connector shown in advanced position.

FIG. 18 shows two close-coupled Walletimages with transmission data chords that are connected to other compatible equipments, not shown.
79 is a data transmission chord, connected to Walletimage.

Operationally Walletimage will be substantially similar to Paperimage in several respects, with additional roles, such as authorizing credit card purchases, when such operations are available to be executed. Functionally it will substantially play the role of a wallet. Business card information may simply be exchanged through docking and transmission of Walletimages. Since it may be expected to carry credit card information with electronic signatures, it may be equipped, even at the basic model level, with various security levels of operation.

### CONCLUSIONS, RAMIFICATIONS, AND SCOPE

The invention presented here provides wide range of applications in the immediate future as well as in the distant future, with synergistic development of Paperimage, Walletimage and compatible equipments and processes.

Imagine the following scenes, to visualize the ramifications:
1. Students from grammar school level to college classification carrying Paperimages, instead of heavy textbooks and notebooks. Students in a classroom dock their Paperimages near their seats. The teacher docks her/his Paperimage at her/his podium station. In a short time the students have transmitted their completed assignments to the teacher's Paperimage. In turn the teacher has transferred the days notes as well as assignments to the students. The teacher has more time to teach, and very little paper to distribute.
2. Similar scenes as above may repeat in seminars, meetings, and other group settings.
3. A family visits their local library, each member carrying his/her personal Paperimage. Instead of bringing back books to their home, they have opted for the digital versions on memory cards that can be snapped into Paperimages. When one of them desires at the library to copy a few pages from periodicals, magazines, books, et cetera, he/she docks his/her Paperimages or Walletimages to the futuristic copier. The scanner of the copier copies the digital versions into the docked equipment. No paper copies are made in this situation at this copier.
4. An individual receives monthly statements of many types (utility, phone, bank, investments, credit cards, et cetera) over the internet. He/she, in the desire to be organized and substantially free of paper clutter, downloads them, not necessarily into a computer but, into a dedicated memory card in a Paperimage. The memory card is already organized into electronic chapters/folders for various statements, and each statement's chapter/folder has its allotted sub-chapters/sub-folders for year designations and each year sub-chapter/sub-folder has its twelve storage areas for months of the year and month designations. All the statements thus are neatly organized in their dedicated locations. If the individual does not possess a ‘downloading’ equipment such as a PC with internet service, she/he may opt to visit a (futuristic) dedicated institution, where people routinely bring their Paperimages and in a secure environment, download a variety of periodic personal statements. The specialized institution would be a clearing house for personal statements. The individual's archives at home are in the form of Paperimage memory cards, occupying no more space than a small shoe box, for decades of personal billing and financial statements in electronic form.
5. A shopper routinely docks her/his Walletimage at (futuristic) checkout counters, uploading credit card information and authorizing the purchases. The receipt information is downloaded into the Walletimage. There are no more paper receipts to handle. Such developments will also reduce paper jams and paper-roll reload delays at the cash register.
6. An individual at work or at home, no longer needs to print and copy catalog sheets and instruction manuals. They are all available in readable format for Paperimage. Whether at work or at home, desks will be uncluttered.
7. Even some magazine, newspaper and coupon publishers and advertisers may be inclined to allow Paperimage compatible publications. The poundage of mail delivery per individual will be drastically reduced.
8. Bulk of the paper utilized and stored is drastically reduced at all public institutions.

I claim:

1. In a substantially lightweight electronic equipment, having a plurality of display screens, and comprising:
plural locations and plural means for connecting to said electronic equipment a plurality of equipments compatible to said electronic equipment, and whereby
by connecting to said electronic equipment a plurality of compatible equipments, wherein
each of said connected equipments can have connected to it a plurality of equipments compatible to said equipment, and wherein
the described connecting process is repeatable a plurality of times, electronic data can be transmitted between any one of said connected electronic equipments to a plurality of said connected equipments.

2. The electronic equipment of claim 1 shaped substantially as a foldable notebook and comprising,
two display screens on the inside surfaces of said electronic equipment, whereby by displaying any displayable data stored in said electronic equipment, an individual can look and read said displayed data in substantially similar manner of looking and reading printed graphics and text in a book.

3. The electronic equipment of claim 1 shaped substantially as a foldable notebook and comprising,
one display screen on an inside surface of said electronic equipment,
whereby by displaying any displayable data stored in said electronic equipment, an individual can look and read said displayed data in substantially similar manner of looking and reading printed graphics and text on a sheet of paper.

4. The electronic equipment of claim 1 shaped substantially as a tablet and comprising,
one display screen on a surface of said equipment,
whereby by displaying any displayable data stored in said electronic equipment, an individual can look and read said displayed data in substantially similar manner of looking and reading printed graphics and text on a sheet of paper.

5. The electronic equipment of claim 1 in substantially miniaturized size that can be inserted into a pocket of wearable clothing, and said equipment shaped substantially as a foldable notebook, and comprising one display screen on one of the inside surfaces of said equipment,
whereby by displaying any displayable data stored in said electronic equipment, an individual can look and read said displayed data in substantially similar manner of looking at and reading printed graphics and text on business cards and credit cards.

6. The electronic equipment of claim 1 in substantially miniaturized size that can be inserted into a pocket of wearable clothing, and said equipment shaped substantially as a tablet, and comprising one display screen on one of the surfaces of said equipment,
whereby by displaying any displayable data stored in said electronic equipment, an individual can look and read said displayed data in substantially similar manner of looking at and reading printed graphics and text on business cards and credit cards.
